(19) United States
(12) Patent Application Publication
(10) Pub. No.: US 2012/0013841 A1
(43) Pub. Date: Jan. 19, 2012

(54) Process for tinting the edges of rimless or partially rimmed eyeglass lenses

(76) Inventor: Margaret Jane Montsaroff, Seattle, WA (US)

(21) Appl. No.: 12/839,398

(22) Filed: Jul. 19, 2010

(51) Int. Cl. G02C 11/02; B05D 5/06; G02C 7/02

(52) U.S. Cl. 351/51; 351/159; 351/174; 427/165

(57) ABSTRACT

This process allows a consumer to apply colors to the outer edges of rimless or partially rimless eyeglass lenses, or to translucent eyeglass frames, such that the coloration is visible through the front of the lenses where it serves decorative, cosmetic, or aesthetic purposes. The process further employs materials and methods for applying the color and also for removing it so it can be changed a plurality of times. Users of the invention value the apparent coloration of eyeglasses in accordance with the invention and time-dependent color-changes.

### FIELD OF THE INVENTION

This invention relates to methods for eyeglass wearers to accessorize or customize eyeglasses, and to eyeglasses so modified. The present invention relates particularly to a method for decorating lens rims or eyeglass frames with solid colors or patterns and designs of the consumer's choosing such that the pattern is visible through the front surface of the lens. Said colors can be removed and replaced repeatedly a plurality of times.

### BACKGROUND OF THE INVENTION

Eyeglasses consist of a pair of lenses and a frame, wherein the frame includes a structure for securing the lenses in fixed positions. Eyeglasses and a pair of eyeglasses (since a single unit is used for both of the wearer's eyes) are generally described as “rimless,” wherein most of each lens's perimeter surface (a/k/a perimeter) as seen from the outside comprises the same transparent material as the substantially transparent lens, so the frame's structure for securing said lens occupies no more than 25% of the perimeter surface or is close to transparent; “rimmed,” wherein each lens's perimeter surface is occupied by the frame's structure affixing it to said frame; “translucently rimmed,” wherein the portion of the frame's structure affixing the lenses as seen from the outside is partially translucent; and “partially” rimmed, wherein each lens's perimeter surface is between 25% and 99% covered by the structure affixing it to the frame, typically resulting in just the upper perimeter surface or just the lower perimeter surface being visible (and accessible) to the outside.

Lenses and frames have been produced in many different shapes and designs to enable the wearer to enjoy an aesthetic as well as functional benefit of eyesight correction. In the prior art, lenses and frames are produced in a finite multiplicity of preset shapes and designs, so a wearer who desires a different aesthetic look must obtain additional eyeglasses, which can be costly and time-consuming. Lenses typically account for 75% to 90% of the cost of an eyeglass purchase, making the decision to alter a frame's color or to change frames expensive.

Notable prior art approaches to customizing appearance include a method for changing lens-frame pairings and a method for allowing customization of the frame itself. The former approach risks damage to the lenses after repeated insertions and extractions of lenses from frames and the possibility of a lens not staying securely in the frame when dropped or after extended use. The latter approach requires a frame that is very specific to the decorative process (e.g., has hollow tubes for filling with decorative material), and often entails a time-consuming or difficult process for changing the look (because the filling would have to be cleaned out and then re-inserted into a very narrow channel).

A drawback of rimless and semi-rimless eyeglasses is that they tend to create a white “halo” effect around wearers' eyes. This effect results from light reflecting through the lens rim onto the user's face and is considered detrimental by potential wearers. Manufacturers have offered factory-applied coloration to the rims at the point of purchase, but these color applications are permanent and invariably, without exception, can be changed only by returning the eyeglasses to experts, such as at a store or factory.

Another drawback of prior art eyeglasses for wearers with strong corrective vision prescriptions is the excessive width of the lens perimeter surface as viewed from the outside. Some eyeglass manufacturers have attempted to minimize this effect by shaping or texturing the lens perimeter surface to give the lens perimeter surface the appearance of being narrower or less noticeable.

### SUMMARY OF THE INVENTION

One object of the invention is to overcome drawbacks relating to the compromise designs of prior art devices such as those discussed above. Another object of the invention is to provide users with multiple methods for employing the present invention to create a wide range of colors or design effects. A further object of the invention is to allow erasure and reapplication of the coloration. Another object of the invention is to provide eyeglasses with a variety of colorations based on as few as one pair of eyeglasses.

In brief, the current invention provides a method for a consumer to customize a portion of commercially purchased eyeglasses such as the rimless portion of their lenses and/or eyeglass frames. The method can be executed in a few minutes. It is simple and easily understandable, not requiring experts or experienced personnel. It is also portable. The method allows decoration of the rims of the eyeglass lenses but does not damage the lenses or harm their corrective function. Use of the method also removes the undesirable white halo effect of rimless lenses as noted above, especially for thick lenses, wherein the present invention converts an aesthetic drawback into an aesthetic advantage.

### BRIEF DESCRIPTION OF THE FIGURES

FIG. 1 Example of a pair of PRIOR ART rimless eyeglasses.

FIG. 2 Example of a pair of PRIOR ART partially rimless eyeglasses.

FIG. 3 Illustration of the METHOD of a solid coloration substance being applied to the eyeglass rims (Preferred Embodiment).

FIG. 4 Illustration of the METHOD of removing the coloration substance using a “wipe” with the solvent (part of the Preferred Embodiment).

FIG. 5 Illustration of an alternative METHOD of removing the coloration substance using the solvent contained in the substance itself.

FIG. 6 Examples of PRIOR ART applicators with styluses. Stylus types: Beveled tip (6A), fine point tip for drawing or writing (6B), and brush-style tip (6C).

FIG. 7 Illustration of a design being drawn onto the lens rims.

FIG. 8 Illustration of a design being stenciled onto the lens rims.

### DETAILED DESCRIPTION OF THE FIGURES

Introduction: The figures associated with this invention are of three types:

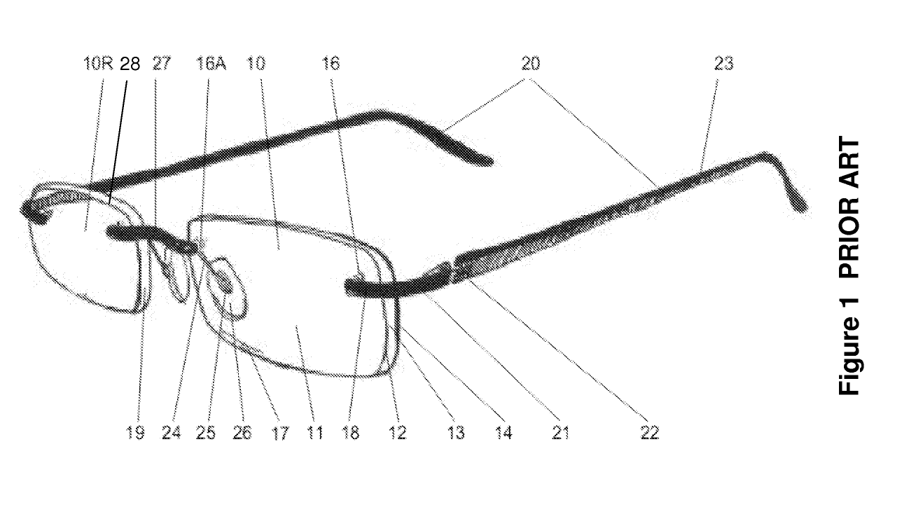

### Depictions of PRIOR ART (FIGS. 1, 2, and 6).

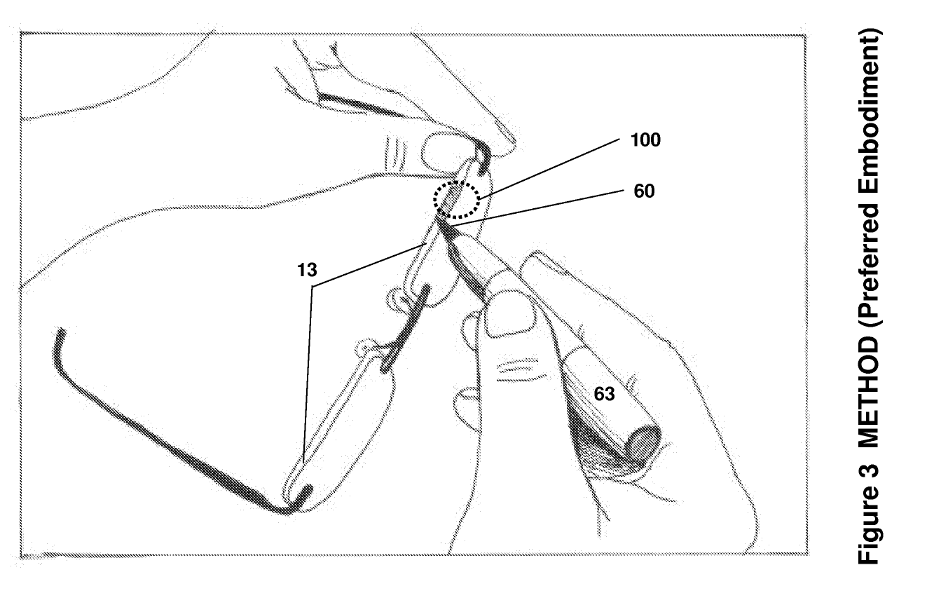

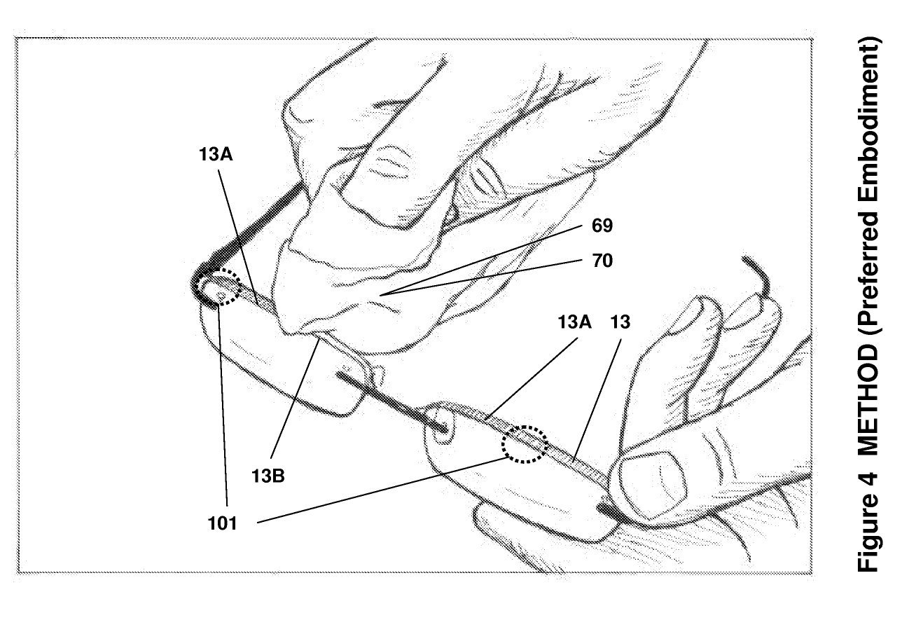

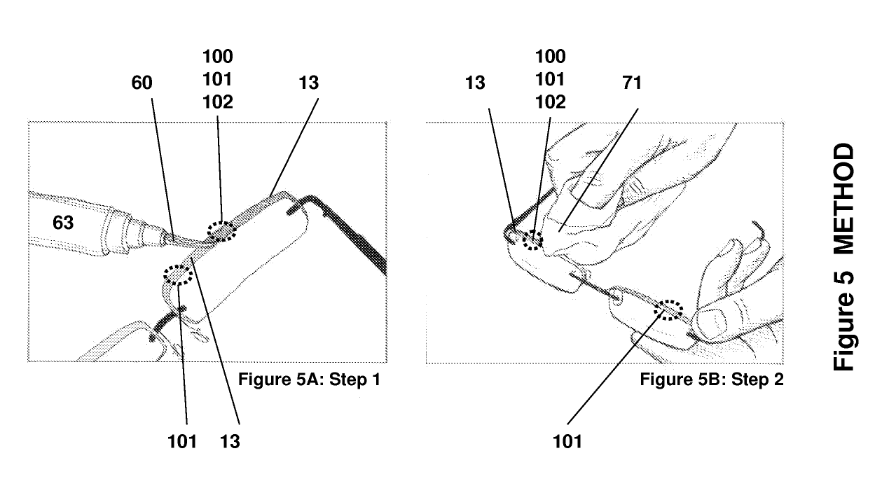

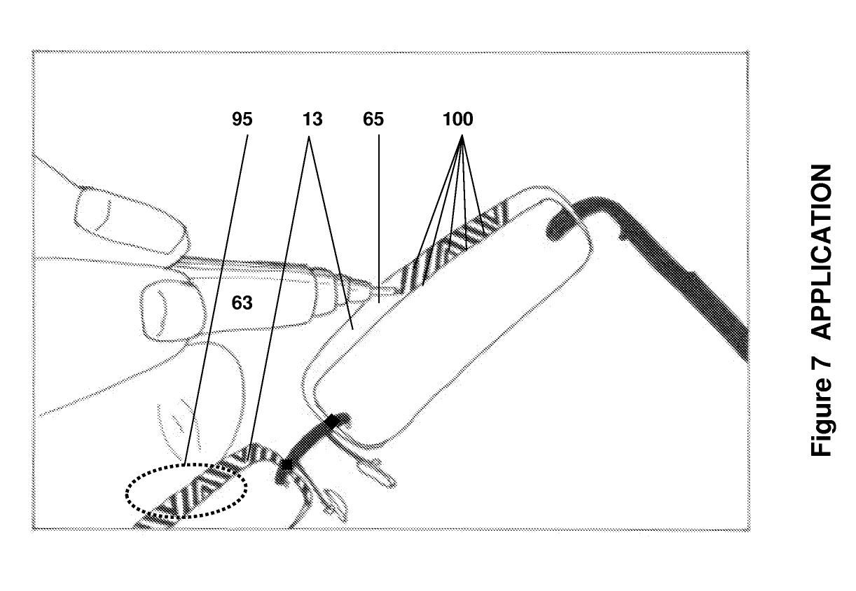

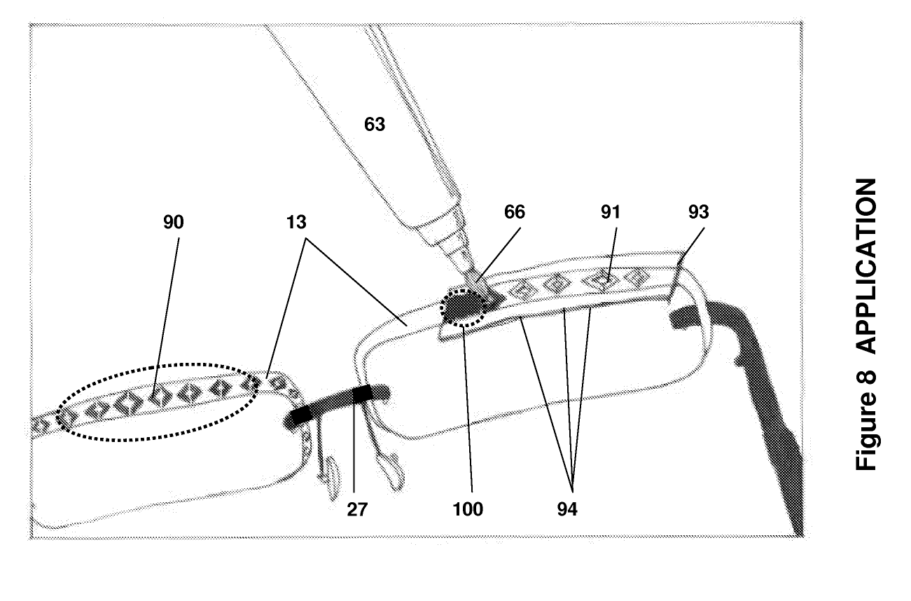

Depictions of the METHODS of this invention (Preferred Embodiment in FIGS. 3 and 4, and an alternative method in FIG. 5).
Depictions of two example APPLICATIONS of the method of this invention (FIGS. 7 and 8).

Reference is now made to FIG. 1, a PRIOR ART depiction of so-called rimless eyeglasses. The eyeglasses comprise a pair of lenses 10 and 10R, and a frame 20. Elements of the apparatus are noted for the left lens 10, but apply equivalently to the right lens 10R. The left lens 10 comprises a front surface 12, a back surface 14, and between them an interior volume 11 (sometimes called the bulk). The front surface 12 and/or back surface 14 are often complicated, such as by multiple facets in the case of bifocals or trifocals, or by shading, metallization, tinting & other coloration, anti-scratch coatings, or anti-reflection coatings. The interior volume 11 is often complicated, such as by graded-index glass or polymers, sun-responsive opacifiers, or an anti-shatter safety lining. The bulk is typically formed from transparent materials with a refractive index of 1.72, 1.67, 1.60, 1.54, “mid-index” lens materials, Tirex™, polycarbonate, or CR-39.

The perimeter surface of a lens 13 (not to be confused in the diagram with the interior volume 11) comprises the surface region exposed between the front surface 12 and back surface 14. The perimeter surface 13 may be thought of as piecing together multiple perimeter surface fragments such as 19 and 28 that are the result of perimeter surface 13 being interrupted or occluded by elements of the frame 20 such as the bridge 27 or the mounting piece 21 for the earpiece 23.

Optical effects visible through the lens include (but are not limited to) ghost images, color mixing, and position-dependent (hence time-dependent) color mixing. Ghost images, both of pure color and of patterns, are visible through the front lens surface 12 because light transmits through and/or reflects off the perimeter surface 13 and is refracted by the lenses 10 at the front lens surface 12. Ghost images may be created by reflections off the back surface 14, and more generally may be created by multiple reflections among the surfaces 12, 13, and 14.

Color mixing occurs where light transmitting or reflecting through differently colored portions of the perimeter surface 13 produces a color effect seen through the front surface 12 that depends on multiple contributions to the output light beam, such as by contributions from different places on the perimeter surface 13. In other words, photons from different origins and/or trajectories are seen added together.

Position-dependent color mixing occurs because the relative angle between a lens and an observer strongly affects what an observer sees when looking at a wearer's lenses 10 and 10R. The relative angle is defined by the position of a lens, the position of an observer, and the azimuth and elevation between them. Strictly speaking, a relative angle is defined for every point on a lens and its orientation to an observer's eye's pupil, though we speak of it here in more aggregated terms. Because the relative angle is seldom stationary for long, the position-dependence becomes time-dependent as well. A key benefit of the invention follows from this time-dependent color mixing appearing to change as wearer and observer move relative to each other.

Region 18 depicts a portion of the lens 10 and its front surface 12 that the frame 20 (more specifically the piece 21) blocks from being available optically to the wearer.

A frame 20 holds the lenses in a fixed relation to the wearer's eyes, and being visible, provides an aesthetic aspect to the eyeglasses in its own right. A typical rimless frame comprises left and right copies of an earpiece 23 that fixes the eyeglasses in position on the head by overhanging the ears; a mounting piece 21 that holds each lens 10 or 10R onto the frame, including a hinged joint 22 which allows pieces 21 and 23 to fold in order to facilitate storage; and a bridge 27 as a third point for holding and positioning the eyeglasses on the wearer's face, specifically by holding a left and right pair of nose-pieces 26 in position, usually by means of a fixture 25 joining it to a flexible strut 24.

There are many ways in the prior art to join a lens 10 to a frame 20. In typical rimless eyeglasses, glue or a bolt through mounting hole 16 affixes a lens 10 to a frame piece 21, and through mounting hole 16A to the bridge 27.

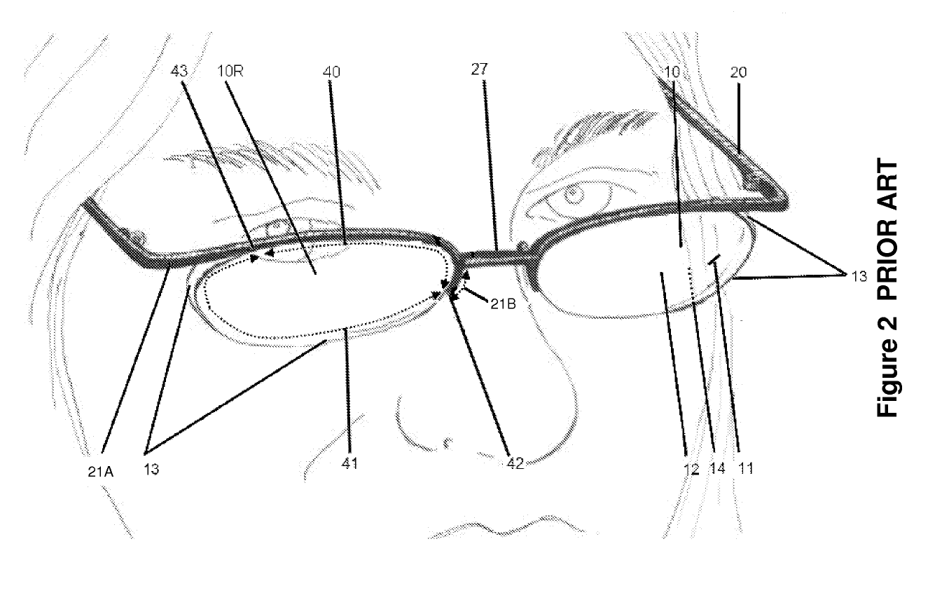

Reference is now made to FIG. 2, a PRIOR ART depiction of so-called “partially rimless” eyeglasses. As with the rimless eyeglasses depicted in FIG. 1, the partially rimless eyeglasses comprise a pair of lenses 10 and 10R, and a frame 20. Elements of the apparatus which are noted here for the left lens 10, apply equivalently to the right lens 10R, and vice versa. The left lens 10 comprises a front surface 12, a back surface 14, and between them an interior volume 11 (sometimes called the bulk). The front surface 12 and/or back surface 14 are often complicated, such as by multiple facets in the case of bifocals or trifocals, or by shading, metallization, tinting and other coloration, anti-scratch coatings, or anti-reflection coatings. The interior volume 11 is often complicated, such as by graded-index glass or polymers, sun-responsive opacifiers, or an anti-shatter safety lining. The perimeter surface of a lens 13 (not to be confused in the diagram with the interior volume 11) comprises the surface region exposed between the front surface 12 and back surface 14.

The features of FIG. 2 PRIOR ART which differ from FIG. 1 and which are directly relevant to the method of this invention are the perimeter surfaces 13 of the lenses 10 and 10R, which in FIG. 2 have an upper portion 40 covered by the frame structure 21A, and a lower portion 41 which remains exposed. The upper portion 40 in this example extends from the point-of-contact 43 between the outer (distal) edge of the upper lens perimeter surface 13 and the frame structure 21A, over the top, and down to the endpoint 42 of a short extension 21B that extends below the bridge 27 of the frame 20.

An example of an alternate embodiment of this figure would have the frame 20 covering the lower perimeter surface 41 and leaving the upper perimeter surface 40 exposed.

The exposed lens perimeter surface sections 40 or 41 in either embodiment of this figure are visible to the wearer and accessible for applying coloration or designs, which are the main uses of this patent.

Reference is now made to FIG. 3, the preferred embodiment of this invention. It depicts one method of applying a solid layer of coloration fluid 100 to the exposed perimeter surface 13 of a lens of rimless eyeglasses (such as the eyeglasses described in FIG. 1, above). The wearer chooses an applicator 63 similar to a Sharpie™- or BIC™-branded commercially available “permanent” marker pen suitable for depositing a single continuous surface layer of the contained applicator coloration fluid 100.

In general, a coloration fluid 100 comprises a coloration substance 101 carried by a solvent fluid 102, the latter evaporating soon after deposition. The coloration substance 101 will typically contain an ink, a paint, a dye, a pigment, a metal, and/or a nanostructured material or emulsion and will produce translucent, opaque, iridescent, or shimmer effects. The solvent 102 will typically be a polar solvent such as a water-based fluid, a non-polar solvent such as an oil-based fluid, or an alcohol-based fluid. To use, the wearer deposits the coloration fluid 100 from an applicator 63 onto the lens perimeter surface 13 by pressing the applicator tip 60 against the lens perimeter surface 13 and drawing said tip along the surface 13. The process may optionally be repeated until a desired coverage, opacity, brush stroke, hue, intensity, and/or saturation of the coloration substance 101 have been obtained.

Reference is now made to FIG. 4, a continuation of the preferred embodiment of this invention, depicting the method by which the wearer takes a disposable cloth 70 (a/k/a wipe) saturated with 70% isopropyl alcohol 69, presses it against the colored lens perimeter surface 13A (comprising a layer of coloration substance 101 affixed to any visible portion of the lens surface 13) and moves it (e.g. draws it back and forth) until substantially all of the coloration substance 101 has been absorbed into the wipe 70 and removed from the lens perimeter surface 13, leaving a clean, colorless surface 13B. The wearer may repeat the process with a fresh wipe or new area of the wipe 70 if a region of the wipe 70 proves to be too saturated with coloration substance removed from the now clean surface 13B to continue to be effective in removing additional coloration substance from 13A.

Reference is now made to FIG. 5, depicting an alternative two-step method for the removal of coloration substance 101. The solvent 102 that the manufacturer of an applicator 63 mixes with the coloration substance 101 to form a coloration fluid 100 is typically delivered with the coloration fluid 100 and then evaporates away leaving the dried coloration fluid 101. The solvent 102 is ideal for use as a cleaning agent, since the previously applied coloration substance 101 liquefies when brought into contact with the fresh application of the coloration fluid 100 because of the presence of the solvent 102, rendering it removable. This fact means that an applicator 63 containing a coloration fluid 100 (such as the specific color that was previously applied in the method associated with FIG. 3 and coats the lens perimeter surface 13A, though other coloration fluids with the same solvent would work as well for this purpose) can be used to draw again on the lens perimeter surface 13A by pressing and drawing the applicator tip 60 along it (FIG. 5A: Step 1), and quickly wiping the newly deposited coloration fluid 100 off with a tissue or soft cloth 71 before the solvent 102 has a chance to evaporate from the coloration fluid 100 (FIG. 5B: Step 2). The tissue or cloth 71 may differ from wipe 70 insofar as it may or may not have a solvent impregnated into it). This method enables the removal of the few coloration substances that are not readily dissolved by isopropyl alcohol.

Both of these methods can also be used by the wearer to remove stray marks from the visual lens surfaces 12 and frame 20 of the eyeglasses that may occur accidentally in the process of applying a coloration substance using the method depicted in FIG. 3.

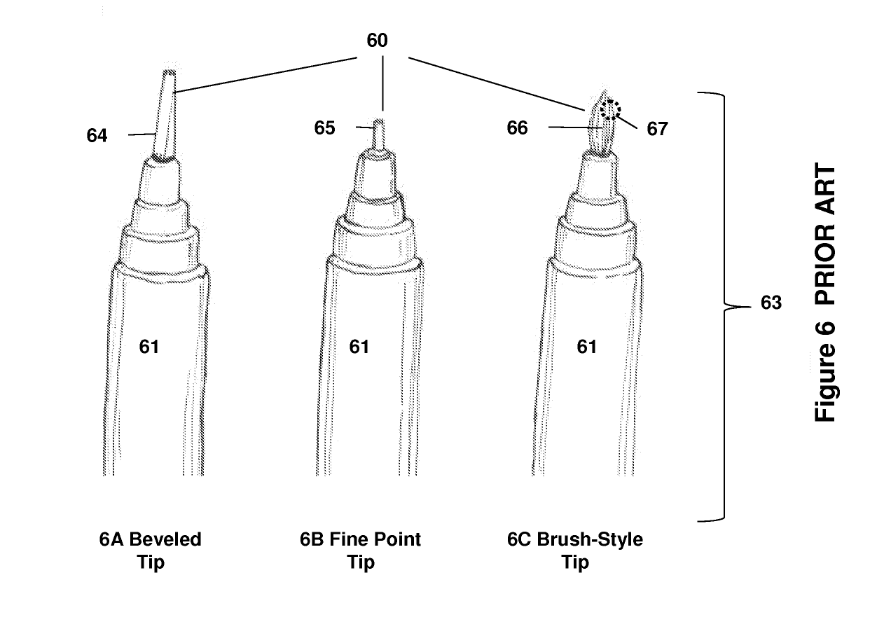

Reference is now made to FIG. 6. Different applicator styluses or tips (collectively 60) may be used for depositing the coloration substance in order to achieve different effects or be easier to use. A PRIOR ART depiction of three examples 64, 65 and 66 of the many applicator tips that may be used for different purposes in the method of this invention are depicted in FIG. 6. An applicator tip 60 is affixed to the end of a chamber 61 which holds the coloration substance 101 in a coloration fluid 100 that flows through the applicator tip 60, depositing the coloration substance 101 on a perimeter surface 13 when the applicator tip 60 is in contact with said surface. A more complete depiction of the entire applicator apparatus 63 was illustrated in FIG. 3. Different applicator tips create different effects, and only a few examples are shown here for the purposes of illustration.

FIG. 6A depicts a “beveled” tip 64 which is wedge shaped and elongated, in comparison to standard PRIOR ART beveled marker pen tips, in order to facilitate the speed of application of coloration substances and the application of coloration substances in narrow spaces between a lens perimeter surface 13 and the connecting frame 20 (both depicted in FIG. 1).

FIG. 6B depicts a “fine-point” tip 65 which matches the characteristics of PRIOR ART fine-tip marker pens and facilitates the ability to apply coloration in designs using fine lines.

FIG. 6C depicts a “brush-style” tip 66 which has bristles (synthetic or natural hair-like fibers 67) which facilitate the application of coloration of finely textured surfaces (such as a stencil) as well as broader flat surfaces of a lens perimeter surface 13.

Again, the PRIOR art applicators and applicator tips referenced in FIGS. 6, 6A, 6B, and 6C are only a few examples of the broad variety of apparatuses that may be used to deploy this invention.

Reference is now made to FIG. 7, which illustrates an alternative application of this invention for creating more decorative effects on a rimless eyeglass lens perimeter surface 13 than just a solid coating of one color. It depicts a wearer using a fine-point applicator tip 65 to apply a coloration fluid 100 in a pattern defined by the wearer onto lens perimeter surface 13. In this example of the use of the invention, a pattern 95 of alternating and parallel slanted lines has been chosen. Any conceivable designs (such as, but not limited to, shapes, text, figures, and blended or layered patterns) are also achievable using the method of this invention.

Reference is now made to FIG. 8, which depicts a user applying coloration fluid 100 in a pattern 90 defined by a stencil 91. The stencil consists of a flexible plastic substance such as, but not limited to, transparent adhesive tape 93, which has been die-cut with openings 94 to allow the wearer-selected coloration fluid 100 to flow onto the lens perimeter surface 13 only in the open areas defined by the die-cut portion of the stencil 91. To accomplish this decorative effect, the wearer presses the adhesive side of the stencil 91 onto the lens perimeter surface 13 with the v-shaped die-cut openings 94 aligned with the surface of 13, and then applies the coloration fluid 100 with an applicator 63, for example, with a brush-style tip 66. After the coloration substance 101 has dried on the stencil 91 and the lens perimeter surface 13, the wearer peels off the stencil 91. What remains is a pattern 90 defined by the openings 94 of the die-cut portions of the stencil 91, herein depicted as simple “v” shapes oriented to create a diamond pattern 90. The application of the method of this invention depicted in FIG. 8 allows the wearer to more quickly and easily achieve a design effect than the freehand approach depicted in FIG. 7. Note that a plurality of colors may be used in conducting the applications illustrated by FIG. 7 and FIG. 8.

We claim the following:

1. A method of customizing eyeglasses, comprising the steps of applying a coloration fluid to some or all of the perimeter surface, of a left lens, a right lens, or both lenses.

2. The method of claim 1 implemented after one or more of said lenses has been affixed in a rimless style.

3. The method of claim 1 implemented after one or more of said lenses has been affixed in a partially rimless or partially-rimless style.

4. The method of claim 1 wherein said step of applying coloration fluid to some or all of said perimeter surface or portion of translucent frames includes depositing a dye, a pigment, a suspension, a paint, and/or a nanostructured material or emulsion.

5. The method of claim 1 wherein said step of applying coloration fluid to some or all of said perimeter surface or portion of translucent frames includes applying a pattern as multiple adjacent regions of coloration fluid and/or as multiple layers of coloration fluid.

6. The method of claim 1 wherein said step of applying a coloration fluid further involves using a plurality of stylus applicators.

7. The method of claim 6 wherein one or more of said plurality of stylus applicators deposits opaque, translucent, oil-based, metallic, iridescent, or shimmer effects.

8. The method of claim 1 further including the step of removing said coloration fluid.

9. The method of claim 8 wherein said step of removing said coloration fluid involves using alcohol.

10. The method of claim 8 wherein said step of removing a coloration substance involves using the solvent that holds the coloration substance in liquid suspension for delivery as coloration fluid.

11. Eyeglasses including a frame and a removable coloration substance on some or all of the perimeter surfaces of a left lens, a right lens, or both lenses.

12. Eyeglasses in accordance with claim 11 including at least one lens with transparent materials with a refractive index of 1.72, 1.67, 1.60, 1.54, “mid-index” lens materials, Tirex™, polycarbonate, or CR-39.

13. A perimeter surface of a lens in accordance with claim 11 including a polished or buff-finished surface.

14. A perimeter surface of a lens in accordance with claim 11 including a pattern as multiple regions and/or layers of a coloration substance.

15. A pattern in accordance with claim 14 including a translucent, opaque, oil-based, metallic, iridescent, or shimmer effect.

16. Eyeglasses in accordance with claim 11 further including a plurality of stylus applicators.

17. A lens in accordance with claim 11 at a first position and orientation, including a point on the front surface of said lens, further including the light seen by an observer at a second relative position and relative orientation, and the relative angle between said first and second positions and orientations.

18. The appearance of a lens to an observer comprising the light from a multiplicity of said points in accordance with claim 17 covering the front surface of said lens.

19. A second appearance of said lens to an observer in accordance with claim 18 at a second relative orientation or relative position or relative angle.

20. The time-dependence of distinct appearances according to claim 18 and claim 19 corresponding to changes in relative position, relative orientation, or relative angle.
